(19) United States
(12) Patent Application Publication
(10) Pub. No.: US 2018/0151000 A1
(43) Pub. Date: May 31, 2018

(54) DEPLOYABLE MIXED AND VIRTUAL REALITY ENVIRONMENT SYSTEM AND METHOD

(71) Applicant: Cix Liv, San Francisco, CA (US)

(72) Inventor: Cix Liv, San Francisco, CA (US)

(21) Appl. No.: 15/822,165

(22) Filed: Nov. 26, 2017

Related U.S. Application Data
(60) Provisional application No. 62/426,544, filed on Nov. 27, 2016.

(51) Int. Cl. G06T 19/00; H04N 5/222; G06F 3/01

(52) U.S. Cl. CPC G06T 19/006; H04N 5/77; G06F 3/011; H04N 5/2224

(57) ABSTRACT

A deployable mixed reality environment system may include one or more panels. The panels may be positioned or coupled together to form an interior chamber into which a user may be positioned. An actual reality recorder may record a user within the interior chamber and their movements. A system computer may be in communication with a virtual reality headset, with a user input controller, and with the actual reality recorder. The system computer may create and display a virtual reality environment to a user through the virtual reality headset while allowing the user to interact with the virtual reality environment through the user input controller. The system computer may also record the user within the interior chamber and then overlay the virtual reality environment displayed to the user onto the panels, thereby forming a mixed reality which includes the user superimposed into the virtual reality environment.

### CROSS REFERENCE TO RELATED APPLICATIONS

This application claims priority to and the benefit of the filing date of U.S. Provisional Application No. 62/426,544, filed on Nov. 27, 2017, entitled “DEPLOYABLE MIXED AND VIRTUAL REALITY ENVIRONMENT SYSTEM”, which is hereby incorporated by reference in its entirety.

### APPENDIX TO THE SPECIFICATION

This application contains an appendix labeled as “Appendix_A”. The entire contents of which are hereby incorporated by reference in their entirety.

### FIELD OF THE INVENTION

This patent specification relates to the field creating mixed reality environments. More specifically, this patent specification relates to systems that are configured to provide a deployable mixed reality and virtual reality environments which may be used for the simultaneous display of virtual reality and actual reality elements.

### BACKGROUND

Virtual reality activities, such as virtual reality games and virtual reality simulations provide an exciting and immersive recreational activity and training. These activities are able are to create and display three dimensional (3D) environments to a user typically through the use of a headset which may be worn by the user. The headset comprises one or more display screens and motion sensors which are able to change areas of the virtual 3D environment displayed to the virtual reality user as the virtual reality user moves their head to simulate views the user would experience if they were actually in the virtual 3D environment.

Unfortunately, the experience of the user in the virtual 3D environment is not able to be readily shared with other individuals. While the other individuals may be able to watch a the virtual 3D environment displayed to the virtual reality user, the display is not able to convey to the other individuals the immersion into the virtual 3D environment that the virtual reality user is experiencing. Additionally, in order for the other individuals to watch the physical motions of the virtual reality user, they must stop watching the displayed virtual 3D environment in order to observe the virtual reality user. Conversely, in order for the other individuals to watch the displayed virtual 3D environment being shown to the virtual reality user, they must stop watching the virtual reality user in order to observe the displayed virtual 3D environment. This dissociation makes watching a virtual reality user less enjoyable to the other individuals.

Furthermore, the experience of the user in the virtual 3D environment is not able to be readily shared with the virtual reality user should they desire to watch themselves and displayed virtual 3D environment when not using a virtual reality headset. Traditionally, if a virtual reality user wanted to watch themselves enjoying a virtual reality experience, they would either have to watch a recording of themselves wearing a virtual reality headset and a separate recording of the virtual 3D environment, such as on a split screen display. Again, this dissociation makes watching a virtual reality user less enjoyable to virtual reality user and therefore also to any other individuals.

Therefore, a need exists for novel systems for creating mixed reality environments. A further need exists for novel systems that are configured to provide a deployable mixed reality environment which may be used for the simultaneous display of virtual reality and actual reality elements. Finally, a need exists for novel deployable mixed reality environment systems which are able eliminate disassociation between the recording of the virtual 3D environment and the user of the virtual 3D environment for observers that are not using virtual reality equipment.

### BRIEF SUMMARY OF THE INVENTION

A deployable mixed and virtual reality environment system is provided. The system may form a physical environment which may be used for the simultaneous display of virtual reality and actual reality elements. In some embodiments, the system may include a first sidewall panel, a second sidewall panel, a front wall panel, an optional rear wall panel, an optional ceiling wall panel, and an optional floor panel. Each panel may comprise a keying surface and the panels may be positioned or coupled together so that the keying surfaces are oriented towards each other to form an interior chamber into which one or more users may be positioned. Preferably, the interior chamber may be sized to accommodate at least one human user while allowing the user to freely move within the interior chamber. A light source may provide illumination into the interior chamber. An actual reality recorder may record a user within the interior chamber and their movements.

In some embodiments, a system computer may be in communication with a virtual reality headset, with a user input controller, and with the actual reality recorder.

In further embodiments, the system computer may create and display a virtual reality environment to a user through the virtual reality headset while allowing the user to interact with the virtual reality environment through user input provided by the user input controller and/or the virtual reality headset.

In further embodiments, the system computer may also record the user within the interior chamber against one or more keying surfaces and then overlay the virtual reality environment displayed to the user onto the recorded keying surfaces, thereby forming a mixed reality which includes the user superimposed or overlaid into the virtual reality environment.

In still further embodiments, or more optional support piers, such as vertical support piers and lateral support piers, may optionally be coupled to one or more of the panels to position the panels so as to form the desired shape of the interior chamber.

According to another embodiment consistent with the principles of the invention, a method of providing a mixed reality is provided. In some embodiments, the method may comprise the steps of: displaying a virtual reality environment to a user via a virtual reality headset, the virtual reality headset in communication with a processor of a system computer configured to generate the virtual reality environment; recording the user and a keying surface with an actual reality recorder, in which the user is positioned within an interior chamber, the interior chamber having the keying surface; overlaying, via the processor of the system computer, the virtual reality environment displayed to the user onto the keying surface in the recording generated by the actual reality recorder to form a mixed reality; and providing the mixed reality to a display screen of an electronic device, the mixed reality including the user superimposed into the virtual reality environment.

In further embodiments of the method, the system computer may be in communication with a positioning sensor, and the system computer may enable the user to interact with the virtual reality environment through input provided by the positioning sensor.

In further embodiments of the method, the system computer may be in communication with a user input controller, and the system computer may enable the user to interact with the virtual reality environment through input provided by the user input controller.

In further embodiments of the method, the virtual reality environment may include a virtual reality object, and the system computer may enable the user to interact with the virtual reality object through input provided by the user input controller.

In further embodiments of the method, the actual reality recorder may be configured to generate a recording of the user, the user input controller, and the keying surfaces within the interior chamber, and the system computer may overlay or superimpose the virtual reality object onto the user input controller in the recording generated by the actual reality recorder when forming the mixed reality.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an illustrative example of some of the components and computer implemented methods which may be found in a deployable mixed reality environment system according to various embodiments described herein.

FIG. 2 illustrates an example of mixed reality displayed on a display screen of an electronic device according to various embodiments described herein.

FIG. 3 shows a block diagram of an example of a method of providing mixed reality according to various embodiments described herein.

FIG. 4 depicts a block diagram of another example of a method of providing mixed reality according to various embodiments described herein.

FIG. 5 illustrates a block diagram illustrating an example of a system computer and some components of a system as described in various embodiments herein.

FIG. 6 shows another illustrative example of some of the components and computer implemented methods which may be found in a deployable mixed reality environment system according to various embodiments described herein.

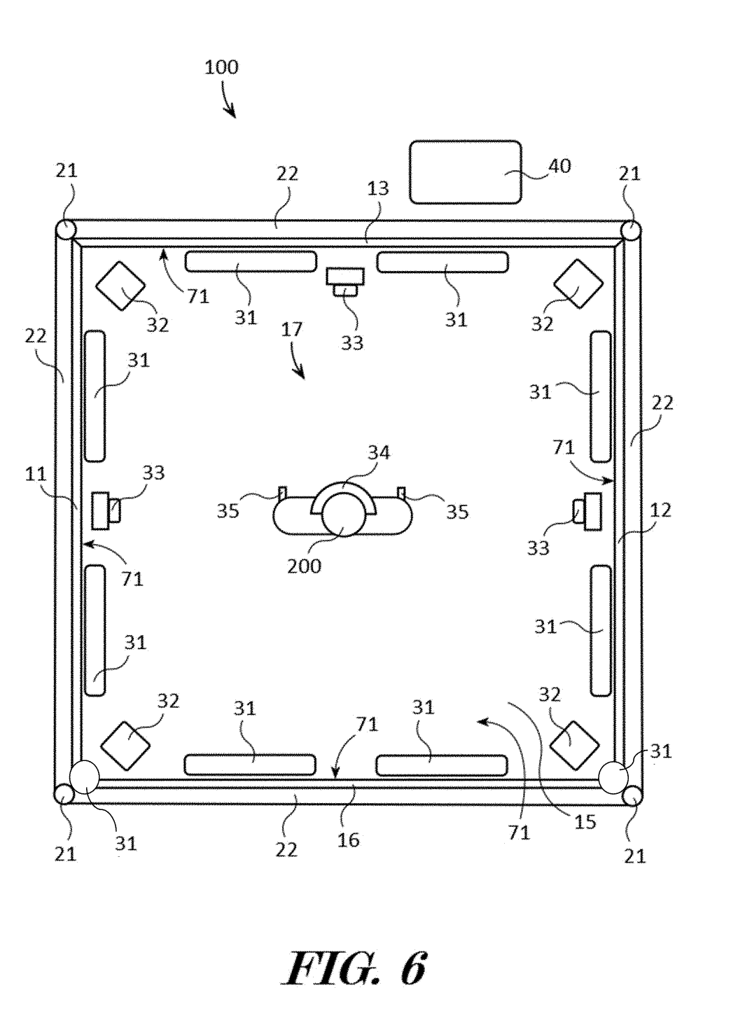

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

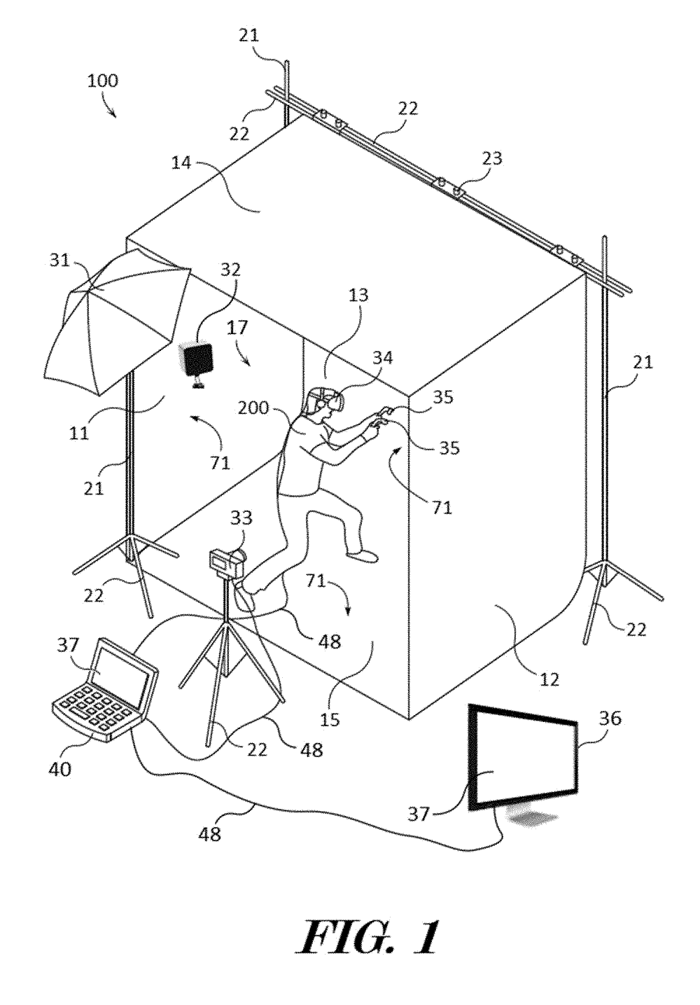

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

### Definitions

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “electronic device” as used herein is a type of computer comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, wearable computers such as Apple Watch, other smartwatches, Fitbit, other wearable fitness trackers, Google Glasses, and the like.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New systems for creating mixed reality environments are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. As perhaps best shown by FIG. 1, an illustrative example of some of the physical components which may comprise a deployable mixed reality environment system (“the system”) 100 according to some embodiments is presented. The system 100 is configured to form a physical environment which may be used for the simultaneous display of virtual reality and actual reality elements. The system 100 is also configured to be readily deployable so as to allow the system 100 to be easily set up and taken down.

In some embodiments, the system 100 may comprise a first sidewall panel 11, a second sidewall panel 12, a front wall panel 13, a ceiling wall panel 14, and a floor panel 15. In yet further embodiments, the system 100 may comprise a rear wall panel 16 essentially enclosing the interior chamber 17 on all sides. The panels 11, 12, 13, 14, 15, 16, may be positioned or coupled together to form an interior chamber 17 into which a user 200 may be positioned. Preferably, the interior chamber 17 may be sized to accommodate a human user 200 while allowing the user to freely move within the interior chamber 17. One or more support piers, such as vertical support piers 21 and lateral support piers 22 may be coupled to the panels 11, 12, 13, 14, 15, 16, to position the panels 11, 12, 13, 14, 15, 16, so as to form the desired shape of the interior chamber 17. A light source 31 may provide illumination into the interior chamber 17 and may optionally be mounted to one or more vertical support piers 21 or lateral support piers 22. An actual reality recorder 33 may record a user 200 within the interior chamber 17 and may record their movements within the interior chamber 17. In some embodiments, the actual reality recorder 33 may be controlled by a robot or autonomous program. A system computer 40 may be in communication with a virtual reality headset 34, with a user input controller 35, and with the actual reality recorder 33. The system computer 40 may create and display a virtual reality environment 83 to a user 200 through the virtual reality headset 34 while allowing the user 200 to interact with the virtual reality environment 83 through the user input controller 35. The system computer 40 may also record the user 200 within the interior chamber 17 and then overlay or superimpose the virtual reality environment displayed to the user 200 onto the panels 11, 12, 13, 14, 15, 16, thereby forming a mixed reality 81 which includes the user 200 superimposed into the virtual reality environment 83.

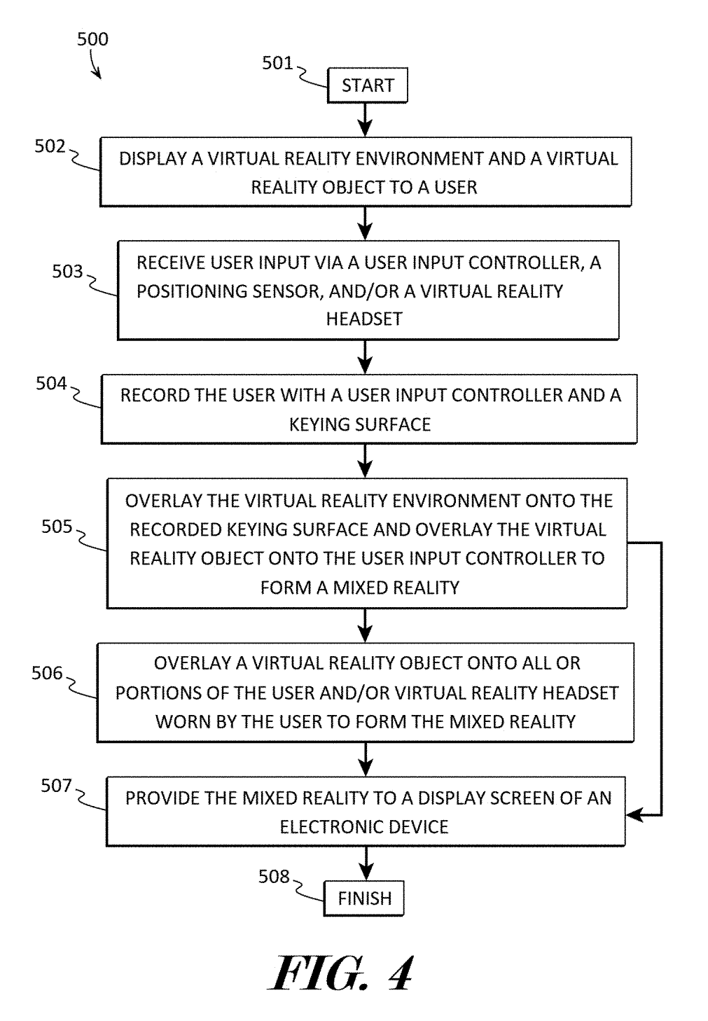

In some embodiments, a system computer 40 may create a virtual reality environment 83 which may be displayed to the user 200 through a virtual reality headset 34. The user 200 may provide input to the system 100 via one or more user input controllers 35 and/or via information provided by movement of the virtual reality headset 34 which the system computer 40 may interpret to allow the user 200 to interact with the virtual reality environment 83. Information describing the user 200 within the interior chamber 17 may be recorded by an actual reality recorder 33 and communicated to the system computer 40. The information provided by the actual reality recorder 33 may contain visual information of the user 200 against one or more panels 11, 12, 13, 14, 15, 16. In yet further embodiments, the system 100 may comprise one or more positioning sensors 32, preferably positioned in one or more pairs around the chamber 17, which may be configured to emit bursts of light (IR, laser, etc.) allowing the system 100 to determine the location and/or movements of a user 200 within the chamber 17. In this manner, the system computer 40 may be provided a video stream or recording of the user 200 against a monochromatic background which may be formed by one or more keying surfaces 71 optionally illuminated by one or more light sources 31. The processor 41 (FIG. 4) may then overlay or superimpose the virtual reality environment 83 onto the monochromatic background recorded via the actual reality recorder 33 using a process such as chroma keying to form mixed reality 81 which may be displayed on a display screen 37 of an electronic device 36, such as a display screen of a system computer 40, television or computer monitor, tablet computer, smartphone, or the like.

Chroma keying, or chroma key compositing, is a visual effects/post-production technique for compositing (layering) two images or video streams together based on color hues (chroma range). The technique is commonly used to remove a background from the subject of a photo or video—particularly the newscasting, motion picture and videogame industries. A color range in the foreground footage is made transparent, allowing separately filmed background footage or a static image to be inserted into the scene. This technique is also referred to as color keying, colour-separation overlay, or by various terms for specific color-related variants such as green screen, and blue screen, however, chroma keying can be done with backgrounds of any color that are uniform and distinct, but green and blue backgrounds are more commonly used because they differ most distinctly in hue from most human skin colors. Preferably, no part of the subject being filmed or photographed may duplicate the color used as the backing.

The interior chamber 17 may be bound and formed by one or more panels 11, 12, 13, 14, 15, 16, with each panel 11, 12, 13, 14, 15, 16, comprising a generally flat or planar shape, curved shape, or any other shape which preferably may minimize the formation of shadows on the panels 11, 12, 13, 14, 15, 16. The one or more panels 11, 12, 13, 14, 15, 16, may be configured in any shape and size to form an interior chamber 17 having any shape and size. In preferred embodiments, one or more panels 11, 12, 13, 14, 15, 16, may comprise a generally planar shape. Additionally, two or more panels 11, 12, 13, 14, 15, 16, may be coupled together at any angle relative to each other such as generally 90 degrees as shown in FIG. 1, less than 90 degrees, or greater than 90 degrees thereby forming an interior chamber 17 having any shape and size. For example, the system 100 may comprise an elongated front wall panel 13 which may be planar and semi-circular in shape with a ceiling wall panel 14 and a floor panel 15 opposingly coupled to the front wall panel 13. In this manner, the interior chamber 17 bound and formed by the panels 13, 14, 15, may be partially cylindrical in shape.

In some embodiments, the system 100 may comprise a first sidewall panel 11, a second sidewall panel 12, a front wall panel 13, a ceiling wall panel 14, and a floor panel 15 so as to for a five sided or open rectangular prism. However, in other embodiments, the system 100 may comprise one, two, three, four, six, seven, eight, nine, ten, or more panels 11, 12, 13, 14, 15, 16. In further embodiments, the system 100 may comprise a first sidewall panel 11, a second sidewall panel 12, a front wall panel 13, a ceiling wall panel 14, a floor panel 15, and a rear wall panel 16 so as to for a six sided or closed rectangular prism, and one of the panels 11, 12, 13, 14, 15, 16, may be movable, such as by being configure as a door or curtain, so that a user 200 and objects may enter and exit the interior chamber 17.

In some embodiments, the system 100 may be portable and configured to be deflated, disassembled, and/or collapsible into a compact state for easy storage and transportation. In further embodiments, one or more of the panels 11, 12, 13, 14, 15, 16, may be made from a flexible material such as vinyl or PVC plastic and all or portions of the panel(s) 11, 12, 13, 14, 15, 16, may be inflatable, so as to have one or more air chambers that when inflated may support the positioning and orientation of one or more panels 11, 12, 13, 14, 15, 16, relative to each other.

In further embodiments, the system 100 may comprise one or more support piers, such as vertical support piers 21 and/or lateral support piers 22, which may be positioned to form the perimeter corners of the interior chamber 17 of the system 100 and which may be used to support one or more panels 11, 12, 13, 14, 15, 16, and/or to position the panels 11, 12, 13, 14, 15, 16, relative to each other. In further embodiments, the support piers 21,22, may be positioned or arranged so the system 100 has five sides, formed by the panels 11, 12, 13, 14, 15, 16, and may be arranged in a square or rectangular shape, however, systems 100 having interior chambers 17 of other shapes such as round, oval, triangular, etc. are contemplated herein.

In some embodiments, the support piers 21,22, may be made from metal such as aluminum or other rigid materials such as plastic or wood. In alternative embodiments, one or more support piers 21,22, may be made from a flexible material such as vinyl or PVC plastic and all or portions of the support pier(s) 21,22, may be inflatable, so as to have one or more air chambers that when inflated may support the positioning and orientation of one or more panels 11, 12, 13, 14, 15, 16, relative to each other. In further embodiments, the support piers 21,22, may be configured to be telescoping, collapsible, or foldable to reduce their size or length when not in use. In further embodiments, each support pier 21,22, may include multiple pier sub pieces, rods, or tubes with diameters or widths of various sizes allowing the sub pieces to slidably engage inside each other in a telescoping fashion. In some embodiments, each support pier 21,22, may have one or more adjustable locking elements configured to temporally secure each of the pier sub pieces in either an extended telescoping configuration or a collapsed telescoping configuration, for example, by twisting the adjustable locking element in a first direction to allow the pier sub pieces to freely move relative to each other and twisting the adjustable locking element in a second direction preventing the pier sub pieces from freely moving relative to each other.

It should be understood to one of ordinary skill in the art that the panels 11, 12, 13, 14, 15, 16, and interior chamber 17 may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

In some embodiments, a panel 11, 12, 13, 14, 15, 16, may be made of or comprise a flexible material such as natural or synthetic rubber, flexible plastics such as polyvinyl chloride, synthetic fabrics such as polyester, acrylic, nylon, rayon, acetate, spandex, lastex, and Kevlar, and natural fabrics such as coir, cotton, hemp, jute, canvas, flax, leather, linen, ramie, wool, silk, or any other suitable flexible natural or synthetic material including combinations of materials. In other embodiments, a panel 11, 12, 13, 14, 15, 16, may be made of or comprise a generally rigid material such as drywall, hard plastics, cardboard, metal alloys, wood, hard rubbers, carbon fiber, fiber glass, resins, polymers or any other suitable materials including combinations of materials or any other suitable rigid material. In still further embodiments, a panel 11, 12, 13, 14, 15, 16, may be made of or comprise a generally rigid material and a flexible material. In preferred embodiments, one or more panels 11, 12, 13, 14, 15, 16, may be coupled together or supported by one or more support piers 21, 22, with one or more mounting fasteners 23 which may be temporary or removable fasteners such as hook and loop style fasteners (e.g. Velcro), hooks, pins, screws, buttons, zippers, clips, and the like. In other embodiments, one or more panels 11, 12, 13, 14, 15, 16, may be coupled together or supported by one or more support piers 21, 22, with one or more mounting fasteners 23 which may be generally non-removable such as adhesives, rivets, chemical bonding, heat bonding, or any other suitable method.

In some embodiments, each panel 11, 12, 13, 14, 15, 16, may comprise a keying surface 71. The panels 11, 12, 13, 14, 15, 16, may be positioned together so that the keying surfaces 71 are oriented towards each other so that the interior chamber 17 may be bound and formed by the keying surface(s) 71 of each panel 11, 12, 13, 14, 15, 16. In this manner, the interior chamber 17 may comprise a first sidewall panel 11 having a keying surface 71, a second sidewall panel 12 having a keying surface 71, a front wall panel 13 having a keying surface 71, a ceiling wall panel 14 having a keying surface 71, and a floor panel 15 having a keying surface 71, and the panels 11, 12, 13, 14, 15, 16, may be positioned together so that the keying surfaces 71 are oriented towards each other.

A keying surface 71 may be uniformly colored so as to facilitate the use of the keying surface 71 in chroma keying applications. In a typical example, a keying surface 71 may be vivid green in color and are commonly called “green screens”. Chroma keying allows media technicians and applications to easily separate green screens from people and objects positioned in front of them and to replace the green screens with any desired visual overlay. In some embodiments, a keying surface 71 may be bright green or bright blue, because these hues differ so greatly from human skin tones and aren't usually found in clothing. In other embodiments, a keying surface 71 may configured with any other color.

In some embodiments, a keying surface 71 of a panel 11, 12, 13, 14, 15, 16, may be made of or may comprise a flexible material such as natural or synthetic rubber, flexible plastics such as polyvinyl chloride, synthetic fabrics such as polyester, acrylic, nylon, rayon, acetate, spandex, lastex, and Kevlar, and natural fabrics such as coir, cotton, hemp, jute, canvas, flax, leather, linen, ramie, wool, silk, or any other suitable flexible natural or synthetic material including combinations of materials. In other embodiments, a keying surface 71 of a panel 11, 12, 13, 14, 15, 16, may be made of or may comprise a generally rigid material such as drywall, hard plastics, cardboard, metal alloys, wood, hard rubbers, carbon fiber, fiber glass, resins, polymers or any other suitable materials including combinations of materials or any other suitable rigid material.

In some embodiments, the system 100 may comprise a light source 31 which may be positioned to provide illumination into the interior chamber 17 so that all or portions of the interior chamber 17 may be illuminated by the light source 31. Optionally, one or more light sources 31 may be positioned within and/or outside of the interior chamber 17. In some embodiments, two or more light sources 31 may be optionally arranged in series and positioned within the interior chamber 17, preferably at a corner or junction between two panels 11, 12, 13, 14, 15, 16. In still further embodiments, one or more light sources 31 may be coupled to a support pier 21, 22, and/or a panel 11, 12, 13, 14, 15, 16, with the light element(s) 31 positioned within the interior chamber 17. In preferred embodiments the system 100 may comprise one or more light sources 31 which may be positioned to provide substantially uniform illumination within the interior chamber 17 so that the keying surfaces 71 of the one or more panels 11, 12, 13, 14, 15, 16, appear to be approximately the same color and without shadows or dim regions. In some embodiments, a light source 31 may include softbox light diffusion panels and/or light reflectors which may be used to direct and diffuse light into the interior chamber 17. Illumination by a light source 31 may be provided by a light emitting diode (LED), an organic light-emitting diode (OLED), incandescent light bulb, fluorescent light, bulb halogen light bulb, high-intensity discharge light bulb, laser light emitter, electroluminescent light source, neon light source, or any other type of suitable light source.

In some embodiments, the system 100 may comprise one or more positioning sensors 32 which may be in communication with the system computer 40. A positioning sensor 32 may be configured to determine the location of a user 200 within the interior chamber 17 and/or to determine movements of a user 200 within the chamber 17. The positioning sensor 32 may provide the location of a user 200 within the interior chamber 17 and/or to the movements of a user 200 within the chamber 17 as input to the system computer 40. The system computer 40 may use the input provided by the positioning sensor 32 to enable the user 200 to interact with the virtual reality environment 83 formed or generated by the system computer 40 and displayed to the user 200 via the virtual reality headset 34. Preferably, one or more positioning sensors 32 may be positioned in one or more pairs in and/or around the interior chamber 17. In some embodiments, a positioning sensor 32 may be configured to emit bursts of light (IR, laser, etc.) which may be interacted with by the user 200 in the interior chamber 17 and used by the positioning sensor 32 to determine the location of a user 200 within the interior chamber 17 and/or to determine movements of a user 200 within the chamber 17. Non-limiting examples of a positioning sensor 32 include the HTC Vive Lighthouse and XBOX Kinect, but other suitable systems and emitters may be used. In some embodiments, a positioning sensor 32 may comprise one or more actual reality recorders 33.

In some embodiments, a positioning sensor 32 may perform inside-out positional tracking. Inside-out tracking is a method of positional tracking commonly used in virtual reality (VR) technologies, specifically for tracking the position of head-mounted displays (virtual reality headsets 34) and motion controller accessories (user input controllers 35). When configured to perform inside-out positional tracking, the positioning sensor 32 may be located on the device being tracked, such as by being located on a virtual reality headset 34 or located on a user input controller 35. In further embodiments, a positioning sensor 32 may perform outside-in positional tracking. Outside-in tracking is a form of positional tracking and, generally, it is a method of optical tracking. When configured to perform outside-in positional tracking, the positioning sensor(s) 32 may in a stationary location and oriented towards the tracked object, such as the user 200, virtual reality headset 34, and/or user input controllers 35, that moves freely around a designated area defined by the intersecting visual ranges of one or more positioning sensor 32. In still further embodiments, the system 100 may comprise one or more positioning sensors 32 configured to perform inside-out positional tracking and one or more positioning sensors 32 configured to outside-in positional tracking.

The system 100 may include one or more actual reality recorders 33 which may record a user 200 within the interior chamber 17 and their movements within the interior chamber 17 so that one or more keying surfaces 71 may also be recorded. An actual reality recorder 33 may be positioned in the interior chamber 17 or proximate to the interior chamber 17 to record the user 200 within the interior chamber 17 so that the user 200 is recorded against or with one or more keying surfaces 71. In some embodiments, the actual reality recorder 33 may comprise a video camera which may be used to record visual information describing the user 200 and one or more keying surface 71 within the interior chamber 17. In further embodiments, the actual reality recorder 33 may comprise an infrared projector, video camera, and processing hardware to track the movement of objects and users 200 within the interior chamber 17 in three dimensions. In further embodiments, an actual reality recorder 33 may include a depth sensing camera configures to determine where a user 200 is within the chamber 17.

The system 100 may include one or more virtual reality headsets 34 which may be in communication with a system computer 40 and which may be used by one or more users 200 to view and/or interact with a virtual reality environment 83 generated or otherwise provided by the system computer 40. In some embodiments, a virtual reality headset 34 may comprise a stereoscopic head-mounted display (providing separate images for each eye), stereo sound, and/or head motion tracking sensors (which may include gyroscopes, accelerometers, structured light systems, etc.). Optionally, a virtual reality headset 34 may also have eye tracking sensors, motion sensors, and/or gaming controllers.

The system 100 may include one or more user input controllers 35 which may be in communication with a system computer 40 and which may be used by one or more users 200 to provide input to the system computer 40 which may be used to interact with a virtual reality environment 83 generated or otherwise provided by the system computer 40. In some embodiments, a user input controller 35 may comprise a device used with games or entertainment systems to provide input to a video game, typically to control an object or character in the game. Example user input controllers 35 include keyboards, mice, gamepads, joysticks, etc. Additionally, user input controllers 35 may include special purpose devices, such as steering wheels for driving games, light guns for shooting games, fishing rods and reels for sporting games, and the like.

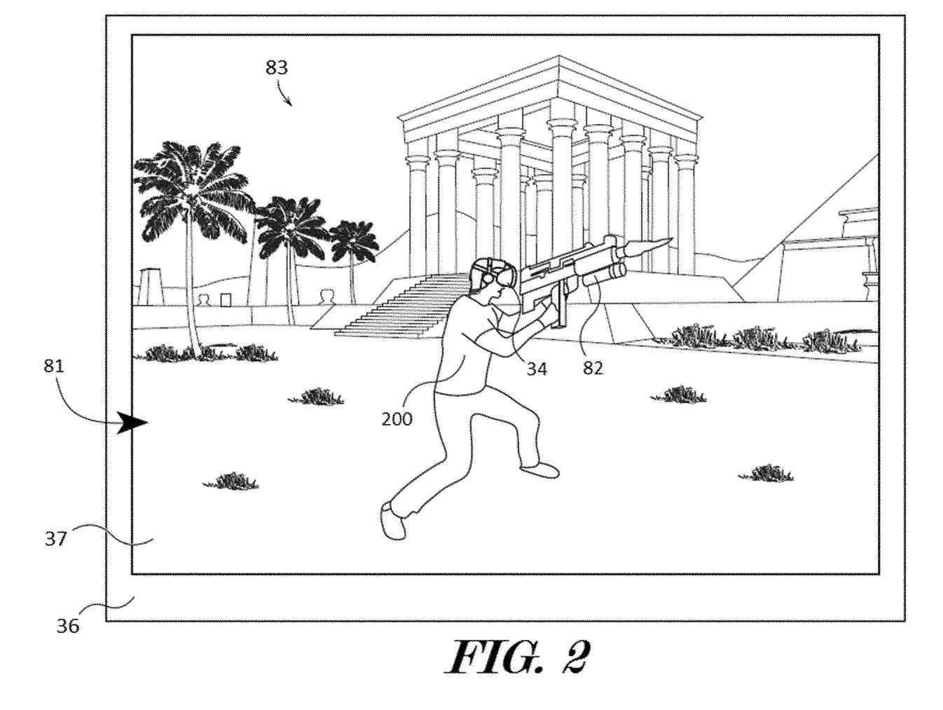

The system 100 may include one or more system computers 40 which may be in communication with one or more positioning sensors 32, actual reality recorders 33, virtual reality headsets 34, and/or user input controllers 35. In some embodiments, a system computer 40 may create and display a virtual reality environment to a user 200 through a virtual reality headset 34 while allowing the user 200 to interact with the virtual reality environment through a user input controller 35. In further embodiments, a system computer 40 may also record the user 200 within the interior chamber 17 via an actual reality recorder 33 and then overlay or superimpose the virtual reality environment 83 displayed to the user 200 onto one or more keying surfaces 71 of the panels 11, 12, 13, 14, 15, 16, against which the user 200 was recorded, thereby forming a mixed reality 81 (FIG. 2) which includes the user 200 superimposed into the virtual reality environment 83.

It should be understood, that the system 100 may use one or more system computers 40 in the creation of mixed reality 81 (FIG. 2). For example, in some embodiments, the system 100 may comprise a single system computer 40 which may create and display the virtual reality environment 83 to the user 200 while also superimposing the virtual reality environment onto the keying surface 71 of one or more of the panels 11, 12, 13, 14, 15, 16, against which the user 200 was recorded. In another example, the system 100 may comprise a first system computer 40 which may create and display the virtual reality environment 83 to the user 200 and a second system computer 40 which may overlay or superimpose the virtual reality environment 83 onto the keying surface 71 of one or more of the panels 11, 12, 13, 14, 15, 16, against which the user 200 was recorded. By providing electronic communication between the first system computer 40 and second system computer 40, their outputs may be combined to form a mixed reality 81 (FIG. 2) which includes the user 200 superimposed into the virtual reality environment 83.

In some embodiments, electronic communication between one or more system computers 40, positioning sensors 32, actual reality recorders 33, actual reality recorder 33, virtual reality headsets 34, and/or user input controllers 35 may be provided by means of one more wired local interfaces 48 or cords as depicted in FIG. 1. In alternative embodiments, electronic communication between one or more system computers 40, positioning sensors 32, actual reality recorder 33, virtual reality headsets 34, and/or user input controllers 35 may be provided by wireless communication protocols such as WiFi, infrared, Bluetooth, or any other suitable wireless communication protocol.

Referring now to FIG. 1 and to FIG. 2, an example of mixed reality 81 displayed on a display screen 37 of an electronic device 36, such as a smartphone, computer, television, or the like, according to various embodiments described herein is depicted. In preferred embodiments, the system computer 40 may create mixed reality 81 which may be displayed on a display screen 37 of an electronic device 36 or which may be stored for viewing at a later time. The mixed reality 81 may comprise virtual reality elements, such as a virtual reality environment 83 and virtual reality objects 82, and actual reality elements, such as the user 200. Optionally, the mixed reality 81 may comprise one or more actual reality elements worn or operated by the user 200 such as a virtual reality headset 34 and/or user input controller(s) 35.

As shown in the example of FIG. 2, the mixed reality 81 comprises the recording of the user 200, which forms actual reality, and the virtual reality environment 83, which forms the virtual reality, upon which the user 200 is superimposed. In this example, the user 200 is superimposed onto a Mediterranean landscape although any other type of environment of landscape may be used. Additionally, one or more virtual reality objects 81, such as the depicted oversized gun, may be superimposed onto the user 200, superimposed onto the virtual reality headset 34, and/or superimposed onto one or more user input controller 35. In this manner, the deployable mixed reality environment system 100 (FIG. 1) may be used for the simultaneous display of virtual reality and actual reality elements as mixed reality 81.

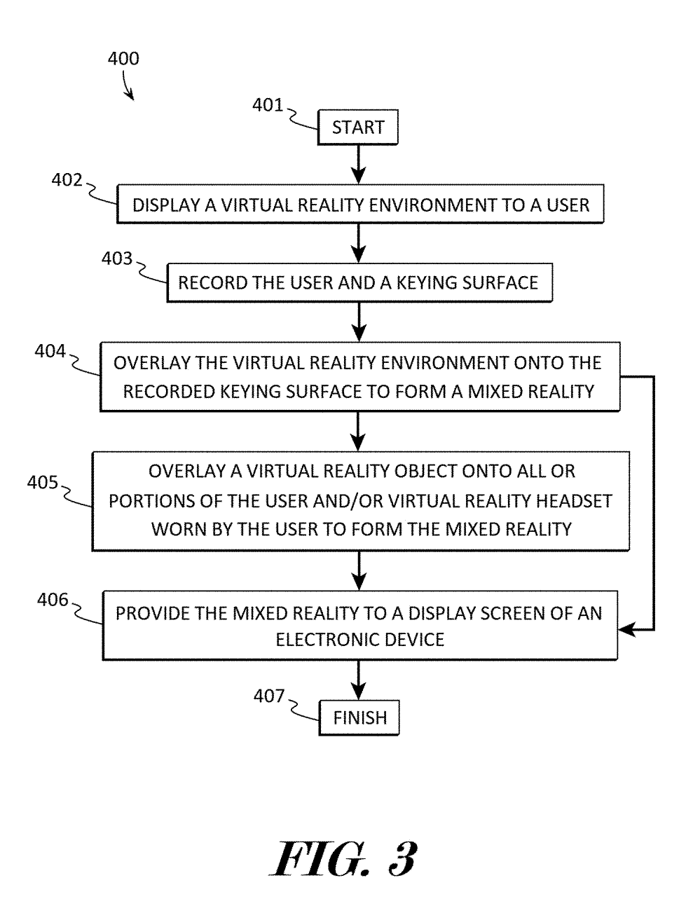

FIG. 3 shows a block diagram of an example of a method of providing mixed reality using a deployable mixed reality environment system (“the method”) 400 according to various embodiments described herein. The method may be used to create mixed reality 81 (FIG. 2) which may be displayed on a display screen 37 of an electronic device 36 in real-time or which may be recorded or stored for viewing at a later time. Preferably, the user 200 may be positioned within the interior chamber 17 of the system 100 (FIG. 1) that comprises one or more keying surfaces 71 for one or more of the steps of the method 400.

In some embodiments, the method 400 may start 401 and a virtual reality environment 83 may be displayed to a user 200 of the system 100 in step 402. Preferably, the virtual reality environment 83 may be created or generated by a system computer 40 and displayed on a virtual reality headset 34 that is being worn by the user 200 which may in communication with the system computer 40. In further embodiments, user input may be provided to the system computer 40 by movement of the virtual reality headset 34 which the system computer 40 may interpret to allow the user 200 to interact with the virtual reality environment.

The user 200 may be recorded within interior chamber 17 against one or more keying surfaces 71 which may be formed or disposed on one or more panels 11, 12, 13, 14, 15, 16, in step 403. In some embodiments, the user 200 may be recorded by an actual reality recorder 33 which may be in communication with a system computer 40. The information provided by the actual reality recorder 33 may contain visual information of the user 200 against one or more keying surfaces 71 of one or more panels 11, 12, 13, 14, 15, 16. In this manner, the system computer 40 may be provided a video stream of the user 200 against a monochromatic background which may be formed by one or more keying surfaces 71 optionally illuminated by one or more light sources 31.

In step 404, the virtual reality environment 38 may be overlaid or superimposed onto the recorded keying surfaces 71 recorded in step 403. In some embodiments, the processor 41 (FIG. 3) of a system computer 40 may overlay or superimpose the virtual reality environment onto the monochromatic background provided by the keying surfaces 71 in the recording of the user 200 within interior chamber 17 against one or more keying surfaces 71 using a process such as chroma keying to form a mixed reality 81. The mixed reality 81 may comprise virtual reality elements, such as a virtual reality environment 83, optionally one or more virtual reality objects 82, and actual reality elements, such as the user 200. Optionally, the mixed reality 81 may comprise one or more actual reality elements worn or operated by the user 200 such as a virtual reality headset 34 and/or user input controller(s) 35.

In optional step 405, one or more virtual reality objects 82 may be overlaid or superimposed onto all or portions of the user 200 and/or onto all or portions of a virtual reality headset 34 worn by the user 200 and recorded in step 403 to form the mixed reality 81. In some embodiments, the processor 41 (FIG. 3) of a system computer 40 may overlay or superimpose one or more virtual reality objects 82, such as the oversized gun in FIG. 2, a hat, a cartoon head, a cartoon wig, etc., onto all or portions of the user 200 and/or onto all or portions of a virtual reality headset 34 worn by the user 200 optionally using a process such as chroma keying to form the mixed reality 81.

Next in step 406 the mixed reality 81 comprising the user 200 and the virtual reality environment may by output by the system computer 40. Optionally, the mixed reality 81 may also comprise one or more virtual reality objects 82. In some embodiments, the mixed reality 81 may be output by being displayed on a display screen 37 of an electronic device 400 and/or optionally on a display screen or device type of I/O interface 48 of a system computer 40. In further embodiments, the mixed reality 81 output by the system 100 may be displayed or communicated to any other electronic device 36 such as smartphones, laptop computers, tablet computers, televisions, and the like having a display screen 37. In still further embodiments, the mixed reality 81 output by the system 100 may be live streamed to one or more other electronic devices. In even further embodiments, the mixed reality 81 output by the system 100 may be stored in memory or a data store accessible to the system 100 for optionally viewing at a later time. Once step 406 is completed, the method 400 may end 407.

FIG. 4 depicts a block diagram of another example of a method of providing mixed reality using a deployable mixed reality environment system (“the method”) 500 according to various embodiments described herein. The method may be used to create mixed reality 81 (FIG. 2) which may be displayed on a display screen 37 of an electronic device 36 in real-time or which may be recorded or stored for viewing at a later time. Preferably, the user 200 may be positioned within the interior chamber 17 of the system 100 (FIG. 1) that comprises one or more keying surfaces 71 for one or more of the steps of the method 400.

In some embodiments, the method 500 may start 501 and a virtual reality environment 83 and a virtual reality object 82 may be displayed to a user 200 of the system 100 in step 502. Preferably, the virtual reality environment 83 and the virtual reality objects 82 may be created or generated by a system computer 40 and displayed on a virtual reality headset 34 that is being worn by the user 200 which may in communication with the system computer 40. In some embodiments, user input may be provided to the system computer 40 by movement of the virtual reality headset 34 which the system computer 40 may interpret to allow the user 200 to interact with the virtual reality environment. In further embodiments, the system 100 may comprise a user input controller 35 which may be held or otherwise operated by the user 200. In some embodiments, the user 200 may interact with one or more user input controllers 35 which may be in communication with the system computer 40 to provide input on how the user 200 desires to interact with the virtual reality environment 83. In this manner, the system computer 40 may enable the user 200 to interact with the virtual reality environment 83 through the input provided by the user input controller 35. In still further embodiments, user input may be provided to the system computer 40 by a positioning sensor 32 and the user 200 may interact with the virtual reality environment 38 through the input provided by the positioning sensor 32.

In step 503, user input may be received via a user input controller 35, a positioning sensor 32, and/or the virtual reality headset 34 by the system computer 40. In some embodiments, the system computer 40 may be in communication with a user input controller 35 through which a user may provide input. The system computer 40 may receive the user input via user input controller 35 and the system computer 40 may enable the user 200 to interact with the virtual reality environment 83 through the input provided by the user input controller 35. In further embodiments, the virtual reality environment 38 may comprise a virtual reality object 82, and the system computer 40 may enable the user 200 to interact with the virtual reality object 82 through the input provided by the user input controller 35. In still further embodiments, the system computer 40 may be in communication with a positioning sensor 32, and the system computer 40 may enable the user 200 to interact with the virtual reality environment 83 and/or virtual reality object 82 through the input provided by the positioning sensor 32.

The user 200 may be recorded within interior chamber 17 against one or more keying surfaces 71 which may be formed or disposed on one or more panels 11, 12, 13, 14, 15, 16, in step 504. The user 200 may be recorded while holding or otherwise operating a user input controller 35 so that the user input controller 35 may also be recorded. In some embodiments, the user 200 may be recorded by an actual reality recorder 33 which may be in communication with a system computer 40. The information provided by the actual reality recorder 33 may contain visual information of the user 200 and the user input controller 35 against one or more keying surfaces 71 of one or more panels 11, 12, 13, 14, 15, 16. In this manner, the system computer 40 may be provided a video stream of the user 200 and the user input controller 35 against a monochromatic background which may be formed by one or more keying surfaces 71 optionally illuminated by one or more light sources 31.

In step 505, the virtual reality environment 38 may be overlaid or superimposed onto the keying surfaces 71 recorded in step 503, and the virtual reality object 82 may be overlaid or superimposed onto the user input controller 35 also recorded in step 503. In some embodiments, the processor 41 (FIG. 3) of a system computer 40 may overlay or superimpose the virtual reality environment 38 onto the monochromatic background provided by the keying surfaces 71 in the recording of the user 200 within interior chamber 17 against one or more keying surfaces 71 using a process such as chroma keying to form a mixed reality 81. The mixed reality 81 may comprise virtual reality elements, such as a virtual reality environment 83, one or more virtual reality objects 82, and actual reality elements, such as the user 200. One or more virtual reality objects 82 may be superimposed or overlaid onto all or portions of the user input controller 35 operated by the user 200 and recorded in step 503 to form a mixed reality. In some embodiments, the processor 41 (FIG. 3) of a system computer 40 may overlay or superimpose one or more virtual reality objects 82, such as the oversized gun in FIG. 2, onto all or portions of the user input controller 35 operated by the user 200 optionally using a process such as chroma keying to form a mixed reality 81. Optionally, one or more virtual reality objects 82 may be superimposed or overlaid onto all or portions of the user 200 and/or onto all or portions of a virtual reality headset 34 worn by the user 200 and recorded in step 503 to form a mixed reality 81.

In optional step 506, one or more virtual reality objects 82 may be superimposed or overlaid onto all or portions of the user 200 and/or onto all or portions of a virtual reality headset 34 worn by the user 200 and recorded in step 403 to form the mixed reality 81. In some embodiments, the processor 41 (FIG. 3) of a system computer 40 may overlay or superimpose one or more virtual reality objects 82, such as the oversized gun in FIG. 2, a hat, a cartoon head, a cartoon wig, etc., onto all or portions of the user 200 and/or onto all or portions of a virtual reality headset 34 worn by the user 200 optionally using a process such as chroma keying to form the mixed reality 81.

Next in step 507 the mixed reality 81 comprising the user 200 superimposed onto the virtual reality environment 83 and a virtual reality object 82 overlaid or superimposed onto the user input controller 35 may by output by the system computer 40. Optionally, the mixed reality 81 may also comprise one or more virtual reality objects 82 overlaid or superimposed onto all or portions of the user 200 and/or onto all or portions of a virtual reality headset 34 worn by the user 200. In some embodiments, the mixed reality 81 may be output by being displayed on a display screen 37 of an electronic device 400 and/or optionally on a display screen or device type of I/O interface 48 of a system computer 40. In further embodiments, the mixed reality 81 output by the system 100 may be displayed or communicated to any other electronic device 36 such as smartphones, laptop computers, tablet computers, televisions, and the like having a display screen 37. In still further embodiments, the mixed reality 81 output by the system 100 may be live streamed to one or more other electronic devices. In even further embodiments, the mixed reality 81 output by the system 100 may be stored in memory or a data store accessible to the system 100 for optionally viewing at a later time. Once step 507 is completed, the method 500 may end 508.

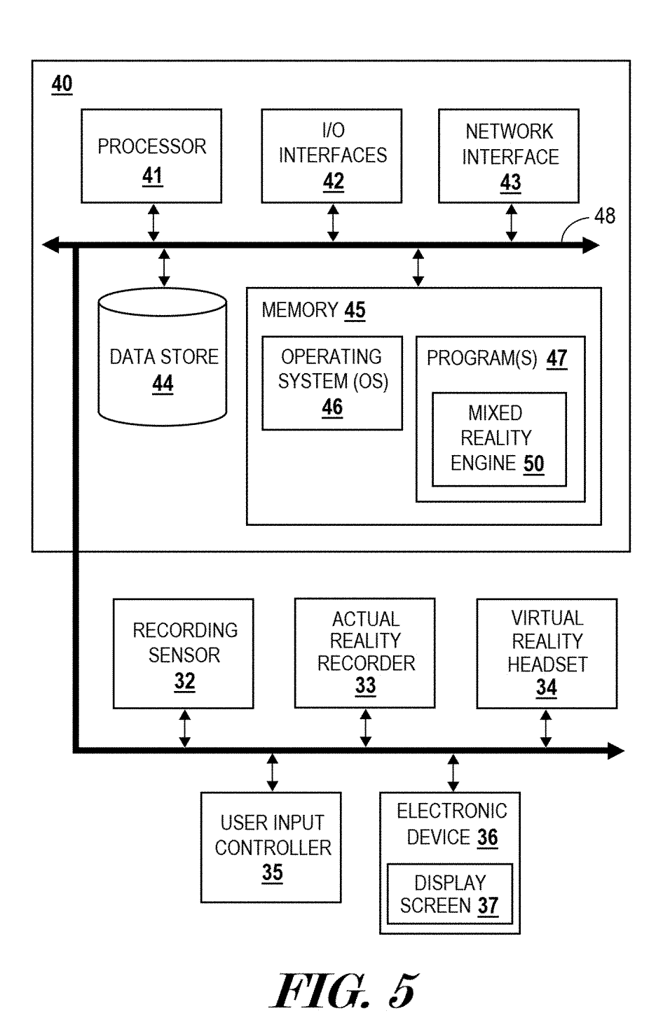

Turning now to FIG. 5, in an exemplary embodiment, a block diagram illustrates a system computer 40 of which one or more may be used in the system 100 or the like. The system computer 40 may be type of electronic device 36 that, in terms of hardware architecture, generally includes a processor 41, input/output (I/O) interfaces 42, a network interface 43, a data store 44, memory 45, and optionally a display screen 37. It should be appreciated by those of ordinary skill in the art that FIG. 4 depicts the system computer 40 in an oversimplified manner, and a practical embodiment may include additional components and suitably configured processing logic to support known or conventional operating features that are not described in detail herein. The components (41, 42, 43, 44, and 45) are communicatively coupled via one or more local interfaces 48. A local interface 48 can be, for example but not limited to, one or more circuit boards, wiring harnesses, buses, or other wired or wireless connections, as is known in the art. A local interface 48 can have additional elements, which are omitted for simplicity, such as controllers, buffers (caches), drivers, repeaters, and receivers, among many others, to enable communications. Further, the local interface 48 may include address, control, and/or data connections to enable appropriate communications among the aforementioned components.

The processor 41 is a hardware device for executing software instructions which may enable the system computer 40 to perform one or more functions and methods described herein. The processor 41 can be any custom made or commercially available processor, a central processing unit (CPU), an auxiliary processor among several processors associated with the system computer 40, a semiconductor-based microprocessor (in the form of a microchip or chip set), or generally any device for executing software instructions. When the system computer 40 is in operation, the processor 41 is configured to execute software stored within the memory 45, to communicate data to and from the memory 45, and to generally control operations of the system computer 40 pursuant to the software instructions. In an exemplary embodiment, the processor 41 may include a mobile optimized processor such as optimized for power consumption and mobile applications.

The I/O interfaces 42 can be used to receive data and user input and/or for providing system output. User input can be provided via a plurality of I/O interfaces 42, such as a keypad, a touch screen, a camera, a microphone, a scroll ball, a scroll bar, buttons, bar code scanner, voice recognition, eye gesture, and the like. System output can be provided via a display device such as a liquid crystal display (LCD), touch screen, and the like. The I/O interfaces 42 can also include, for example, a serial port, a parallel port, a small computer system interface (SCSI), an infrared (IR) interface, a radio frequency (RF) interface, a universal serial bus (USB) interface, and the like. The I/O interfaces 42 can include a graphical user interface (GUI) that enables a user to interact with the system computer 40. Additionally, the I/O interfaces 42 may be used to output notifications to a user and can include a speaker or other sound emitting device configured to emit audio notifications, a vibrational device configured to vibrate, shake, or produce any other series of rapid and repeated movements to produce haptic notifications, and/or a light emitting diode (LED) or other light emitting element which may be configured to illuminate to provide a visual notification.

The network interface 43 enables wireless communication to an external access device or network. Any number of suitable wireless data communication protocols, techniques, or methodologies can be supported by the network interface 43, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 44 may be used to store data. The data store 44 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 44 may incorporate electronic, magnetic, optical, and/or other types of storage media.

The memory 45 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 45 may incorporate electronic, magnetic, optical, and/or other types of storage media. Note that the memory 45 may have a distributed architecture, where various components are situated remotely from one another, but can be accessed by the processor 41. The software in memory 45 can include one or more software programs, each of which includes an ordered listing of executable instructions for implementing logical functions. In the example of FIG. 4, the software in the memory system 45 includes a suitable operating system (O/S) 46 and programs 47.

The operating system 46 essentially controls the execution of other computer programs, and provides scheduling, input-output control, file and data management, memory management, and communication control and related services. The operating system 46 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 47 may include various applications, add-ons, etc. configured to provide end user functionality with the system computer 40. For example, exemplary programs 47 may include, but not limited to, a chroma keying capable application, virtual reality environment and or virtual reality object generating application, a web browser, social networking applications, streaming media applications, games, mapping and location applications, electronic mail applications, financial applications, and the like. In a typical example, the end user typically uses one or more of the programs 47 along with elements of the system 100 to provide a mixed reality to a user 200.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or wifi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a client device such as a personal digital assistant (PDA), laptop computer, or cellular telephone. The LAN communications network and the other communications networks such as cellular wireless and WiFi networks may use electrical, electromagnetic or optical signals that carry digital data streams. The processor system can transmit notifications and receive data, including program code, through the network(s), the network link and the communication interface.

While some materials have been provided, in other embodiments, the elements that comprise the system 100 such as one or more panels 11, 12, 13, 14, 15, 16, optional support piers 21, 22, optional light source 31, optional positioning sensor 32, optional actual reality recorder 33, optional system computer 40, optional virtual reality headset 34, optional user input controller 35, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the system 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the system 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the system 100 may be coupled by being one of connected to and integrally formed with another element of the system 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A deployable mixed reality environment system, the system comprising:
a first sidewall panel comprising a keying surface, a second sidewall panel comprising a keying surface, a front wall panel comprising a keying surface, a ceiling wall panel comprising a keying surface, and a floor panel comprising a keying surface, wherein the panels are positioned together so that the keying surfaces are oriented towards each other to form an interior chamber;
an actual reality recorder configured to generate a recording of a user and the keying surfaces within the interior chamber; and
a system computer in communication with a virtual reality headset and with the actual reality recorder,
wherein the system computer creates and displays a virtual reality environment to a user through the virtual reality headset, and
wherein the system computer overlays the virtual reality environment displayed to the user onto the keying surfaces in the recording generated by the actual reality recorder to form a mixed reality, the mixed reality displayable on a display screen of an electronic device as the user superimposed into the virtual reality environment.

2. The system of claim 1, wherein the actual reality recorder comprises a video camera.

3. The system of claim 1, further comprising a light source configured to provide illumination into the interior chamber.

4. The system of claim 3, wherein the light source is positioned within the interior chamber.

5. The system of claim 1, wherein a keying surface of a panel comprises a flexible material, and wherein the panel is selected from the group consisting of the first sidewall panel, the second sidewall panel, the front wall panel, the ceiling wall panel, and the floor panel.

6. The system of claim 1, wherein the system computer is in communication with a positioning sensor, and wherein the system computer enables the user to interact with the virtual reality environment through the input provided by the positioning sensor.

7. The system of claim 1, wherein the system computer is in communication with a user input controller, and wherein the system computer enables the user to interact with the virtual reality environment through the input provided by the user input controller.

8. The system of claim 7, wherein the virtual reality environment comprises a virtual reality object, and wherein the system computer enables the user to interact with the virtual reality object through the input provided by the user input controller.

9. The system of claim 8, wherein the actual reality recorder is configured to generate a recording of the user, the user input controller, and the keying surfaces within the interior chamber, and wherein the system computer overlays the virtual reality object onto the user input controller in the recording generated by the actual reality recorder when forming the mixed reality.

10. A method of providing a mixed reality, the mixed reality comprising a user superimposed into a virtual reality environment and the mixed reality displayable on a display screen of an electronic device, the method comprising the steps of:
displaying a virtual reality environment to a user via a virtual reality headset, the virtual reality headset in communication with a processor configured to generate the virtual reality environment;
recording the user and a keying surface with an actual reality recorder, wherein the user is positioned within an interior chamber, the interior chamber comprising the keying surface;
overlaying, via a processor, the virtual reality environment displayed to the user onto the keying surface in the recording generated by the actual reality recorder to form a mixed reality; and
providing the mixed reality to a display screen of an electronic device, the mixed reality comprising the user superimposed into the virtual reality environment.

11. The method of claim 10, wherein the system computer is in communication with a positioning sensor, and wherein the system computer enables the user to interact with the virtual reality environment through the input provided by the positioning sensor.

12. The method of claim 10, wherein the system computer is in communication with a user input controller, and wherein the system computer enables the user to interact with the virtual reality environment through the input provided by the user input controller.

13. The method of claim 12, wherein the virtual reality environment comprises a virtual reality object, and wherein the system computer enables the user to interact with the virtual reality object through the input provided by the user input controller.

14. The method of claim 13, wherein the actual reality recorder is configured to generate a recording of the user, the user input controller, and the keying surfaces within the interior chamber, and wherein the system computer overlays the virtual reality object onto the user input controller in the recording generated by the actual reality recorder when forming the mixed reality.

15. The method of claim 10, wherein the interior chamber is illuminated by a light source.

16. The method of claim 10, wherein the actual reality recorder comprises a video camera.

17. The method of claim 10, wherein the interior chamber comprises a first sidewall panel comprising a keying surface, a second sidewall panel comprising a keying surface, a front wall panel comprising a keying surface, a ceiling wall panel comprising a keying surface, and a floor panel comprising a keying surface, wherein the panels are positioned together so that the keying surfaces are oriented towards each other.

18. The method of claim 17, wherein a panel is supported by a support pier, and wherein the panel is selected from the group consisting of the first sidewall panel, the second sidewall panel, the front wall panel, the ceiling wall panel, and the floor panel.

19. The method of claim 17, wherein a keying surface of a panel comprises a flexible material, and wherein the panel is selected from the group consisting of the first sidewall panel, the second sidewall panel, the front wall panel, the ceiling wall panel, and the floor panel.

20. The method of claim 17, wherein a panel is generally planar, and wherein the panel is selected from the group consisting of the first sidewall panel, the second sidewall panel, the front wall panel, the ceiling wall panel, and the floor panel.
